(19) United States
(12) Patent Application Publication
(10) Pub. No.: US 2025/0271846 A1
(43) Pub. Date: Aug. 28, 2025

(54) AUTONOMOUS FAULT DIAGNOSTIC TOOLS FOR MANUFACTURING SYSTEMS BY ANALYZING PROCESS RUNS

(71) Applicant: Applied Materials, Inc., Santa Clara, CA (US)

(72) Inventors: Suketu Arun Parikh, San Jose, CA (US); Jimmy Iskandar, Fremont, CA (US); Bradley D. Schulze, Glendale, AZ (US); Duraivelu Dhanapal, Fremont, CA (US); Tsz Keung Cheung, San Jose, CA (US); Isabel Li, Milpitas, CA (US); Minal Shettigar, San Jose, CA (US); Michael D. Armacost, San Jose, CA (US)

(21) Appl. No.: 18/584,068

(22) Filed: Feb. 22, 2024

(51) Int. Cl. G05B 23/02

(52) U.S. Cl. CPC G05B 23/0227

(57) ABSTRACT

A method includes obtaining an event sequence related to a set of runs performed by a process tool that has failed, determining, using the event sequence, an issue causing a failure of the process tool, identifying, based on the issue, a first subset of runs from the set of runs and a second subset of runs from the set of runs, identifying a corrective action to address the issue that caused the failure, and causing the corrective action to be provided.

### TECHNICAL FIELD

The present disclosure relates to electrical components, and, more particularly, to performing autonomous root cause diagnostics for manufacturing systems by analyzing process runs.

### BACKGROUND

Manufacturing of modern materials often involves various deposition techniques, such as chemical vapor deposition (CVD) or physical vapor deposition (PVD) techniques, in which atoms or molecules of one or more selected types are deposited on a semiconductor device (e.g., a substrate) held in low or high vacuum environments that are provided by vacuum processing (e.g., deposition, etching, etc.) chambers. Materials manufactured in this manner can include monocrystals, semiconductor films, fine coatings, and numerous other substances used in practical applications, such as electronic device manufacturing. Many of these applications depend on the purity and specifications of the materials grown in the processing chambers. The quality of such materials, in turn, depends on adherence of the manufacturing operations to correct process specifications. To maintain isolation of the inter-chamber environment and to minimize exposure of substrates to ambient atmosphere and contaminants, various sensor detection techniques are used to monitor processing chamber environment, substrate transportation, physical and chemical properties of the products, and the like to detect potential anomalies and issues. Improving precision, reliability, and efficiency of such monitoring presents a number of technological challenges.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method is provided. The method includes obtaining an event sequence related to a set of runs performed by a process tool that has failed, determining, from the event sequence, an issue causing a failure of the process tool, identifying, based on the issue, a first subset of runs from the set of runs and a second subset of runs from the set of runs, identifying a corrective action to address the issue that caused the failure, and causing the corrective action to be provided.

In another aspect of the disclosure, a system is provided. The system includes a memory and a processing device operatively coupled to the memory, to perform operations including obtaining an event sequence related to a set of runs performed by a process tool that has failed, determining, from the event sequence, an issue causing a failure of the process tool, identifying, based on the issue, a first subset of runs from the set of runs and a second subset of runs from the set of runs, identifying a corrective action to address the issue that caused the failure, and causing the corrective action to be provided.

### BRIEF DESCRIPTION OF THE DRAWINGS

The present disclosure is illustrated by way of example, and not by way of limitation in the figures of the accompanying drawings.

FIG. 1 is a block diagram illustrating an example manufacturing system, in accordance with some implementations of the present disclosure.

FIG. 2 is a top schematic view of an example manufacturing system, in accordance with some implementations of the present disclosure.

FIG. 3 is a block diagram illustrating an example predictive architecture, in accordance with some implementations of the present disclosure.

FIGS. 4A-5 are flow chart of examples methods for implementing autonomous root cause diagnostics for manufacturing systems by analyzing process runs, in accordance with some implementations of the present disclosure.

FIG. 6 is a table illustrating example scenarios for implementing autonomous root cause diagnostics for manufacturing systems by analyzing process runs, according to aspects of the present disclosure.

FIG. 7 is a block diagram illustrating a computer system, according to certain implementations.

### DETAILED DESCRIPTION

Described herein are technologies directed to performing autonomous root cause diagnostics for manufacturing systems by analyzing process runs. A manufacturing system can include one or more process tools, where each process tool includes a set of components that are used to manufacture an object in accordance with a process recipe. One example of a manufacturing system is an electronic device processing system, such as a semiconductor device processing system. A manufacturing system can include one or more process tools. For example, an electronic device processing system (e.g., semiconductor device processing system) can include multiple process tools, where each process tool can include one or more processing chambers.

A process tool can execute a process recipe to perform a process run (“run”). Some process recipes can include tens of steps, hundreds of steps, etc. For example, in the context of electronic device processing systems, process recipes can include steps such as introducing a gas into a processing chamber, heating the chamber environment, changing a composition of gas, purging a chamber, pumping the gas out, changing pressure, moving a substrate from one position to another, creating or adjusting a plasma environment, performing etching, deposition or cleaning steps, etc. Examples of runs include qualification runs and normal runs. Examples of qualification runs include film thickness qualification runs, film defect qualification runs, etc. A normal run is a routine manufacturing process that uses a process recipe to fabricate an electronic device (e.g., not a qualification run).

A manufacturing system (e.g., electronic device processing system) can include at least one processing device that can process amounts of sensor data obtained from multiple sensors, which can be used to analyze the performance of the manufacturing system and processes performed therein. Some manufacturing systems can include many sensors that generate streams of sensor data. For example, an electronic device processing system can include temperature sensors, pressure sensors, chemical sensors, gas flow sensors, motion sensors, position sensor, optical sensors, and other types of sensors. A manufacturing system can have multiple sensors of the same (or similar) type distributed throughout various parts of the manufacturing system. For example, a processing chamber of a process tool can have multiple chemical sensors to detect concentration of chemical vapor at various locations within the processing chamber, multiple temperature sensors to monitor temperatures, pressure sensors to monitor pressure, etc.

When a process tool has a failure (e.g., goes down), it can be difficult to identify the root cause of the issue that caused the failure. This is because there may be many root causes for a particular issue that can cause the failure. Typically, an issue that caused a failure and/or the root cause of the issue that caused the failure can be identified by a field engineer after multiple hours of review. Additionally, multiple iterations of testing may be needed to identify an appropriate corrective action that can address the failure and fix the process tool. Accordingly, it can be time and resource intensive to diagnose a root cause of an issue that caused a failure of a process tool, and fix the process tool (e.g., a processing chamber of the process tool) in accordance with the diagnosis.

Aspects and implementations of the present disclosure address these and other shortcomings of the existing technology by implementing autonomous root cause diagnostics for manufacturing systems by analyzing process runs. In some implementations, a manufacturing system is an electronic device processing system, and a process tool includes a set of processing chambers.

To implement autonomous root cause diagnostics, at least one processing device of the manufacturing system can obtain an event sequence for a set of runs performed by a process tool that has failed. In some implementations, the set of runs includes a set of discrete runs. In some implementations, the set of runs includes a set of continuous runs. For example, obtaining the event sequence can include receiving raw event sequence data related to a set of runs performed by the process tool, and generating the event sequence by processing the raw event sequence data. In some implementations, processing the raw event sequence data to generate the event sequence includes assigning event codes to the raw event sequence data. Examples of events and associated codes (in parentheses) include normal run (p), qualification run for film thickness (QT), qualification run for film defects (QD), tool is down (TD), scheduled downtime (SD), tool alarm (TA), other issue (other), etc.

The at least one processing device can determine an issue causing a failure of the process tool from the event sequence. Examples of issues include defect issues, uniformity issues, yield issues, etc. An issue can correspond to at least one fault pattern. For example, a defect issue can correspond to a fault pattern {QD, QD, TD}. As another example, a uniformity issue can correspond to a fault pattern {QT, QT, TD}. As yet another example, a yield issue can correspond to a fault pattern {p, p, TD}.

In some implementations, determining the issue includes comparing the event sequence to predefined fault patterns stored in a data store (e.g., database). Determining the issue can include performing pattern matching. For example, a predefined fault pattern can be {QD, QD, TD}, which can be defined in the data store as a defect issue. If the event sequence includes the fault pattern {QD, QD, TD}, then the at least one processing device can determine that the issue is a defect issue based on a comparison of the event sequence to the predefined fault patterns, including {QD, QD, TD}, maintained in the data store.

In some implementations, determining the issue includes using a machine learning model (e.g., at least one neural network) trained to infer the issue from the event sequence. For example, the machine learning model can be trained to perform pattern recognition to match the event sequence to an issue based on a fault pattern. Illustratively, if the event sequence includes the fault pattern {QT, QT, TD}, then at least one processing device can use the machine learning model to infer that the issue is a uniformity issue.

The at least one processing device can, using the issue, split the set of runs into a set of bad runs and a set of good runs. A bad run refers to a defective run that results in a failure, such as the process tool going down. A good run refers to a non-defective run that does not result in a failure. For example, assume that an event sequence includes {QD, p, p, QD, p, p, p, p, QD, QD, TD}, and that the processing device determined that the issue is a defect issue (e.g., based on the fault pattern {QD, QD, TD} as described above). The at least one processing device can select the QDs of the fault pattern {QD, QD, TD} as the bad runs to include in the set of bad runs, and select the other QDs of the event sequence as the good runs to include in the set of good runs.

The at least one processing device can identify, from the set of good runs and the set of bad runs, a corrective action to address the issue that caused the failure of the process tool. More specifically, the at least one processing device can identify a root cause of the issue from the set of good runs and the set of bad runs, and then identify the corrective action to address the issue from the root cause.

In some implementations, identifying the root cause of the issue includes obtaining first sensor data (e.g., sensor traces) from the set of good runs and second sensor data from the set of bad runs, identifying a set of sensors based on a comparison of the first sensor data to the second sensor data, and determining the root cause of the issue from the set of sensors. More specifically, the comparison of the first sensor data to the second sensor data can identify one or more sensors that show a difference in sensor behavior, where the one or more sensors define the set of sensors. Identifying the set of sensors can further include ranking the one or more sensors. For example, the ranking can be performed based on difference magnitude in sensor behavior (e.g., in descending order with the sensor having the greatest difference in magnitude being the top ranked sensor). Additionally or alternatively, the ranking can be based on the frequency of identification of the sensors in previous failures (e.g., in descending order with the sensor that has been most frequently identified in previous failures being the top ranked sensor). Additionally, or alternatively, the ranking can be based on the frequency of occurrence of event types identified from the event sequence. Other ranking methods are contemplated. Additionally or alternatively, the ranking can be based on equipment operational parameters. Examples of equipment operational parameters include temperature parameters, radio frequency (RF) calibration parameters, mass flow controller (MFC) calibration parameters, etc.

The root cause can be identified from the set of sensors using any suitable technique. In some implementations, the at least one processing device identifies the root cause by identifying the root cause from a data store (e.g., the same data store described above) that stores information mapping the set of sensors to the root cause. That is, the information can be predefined in the data store. In some implementations, the at least one processing device uses a machine learning model trained to infer the root cause from data representing the set of sensors. For example, the machine learning model can be trained to perform pattern recognition to match the data representing the set of sensors to a root cause based on a sensor pattern.

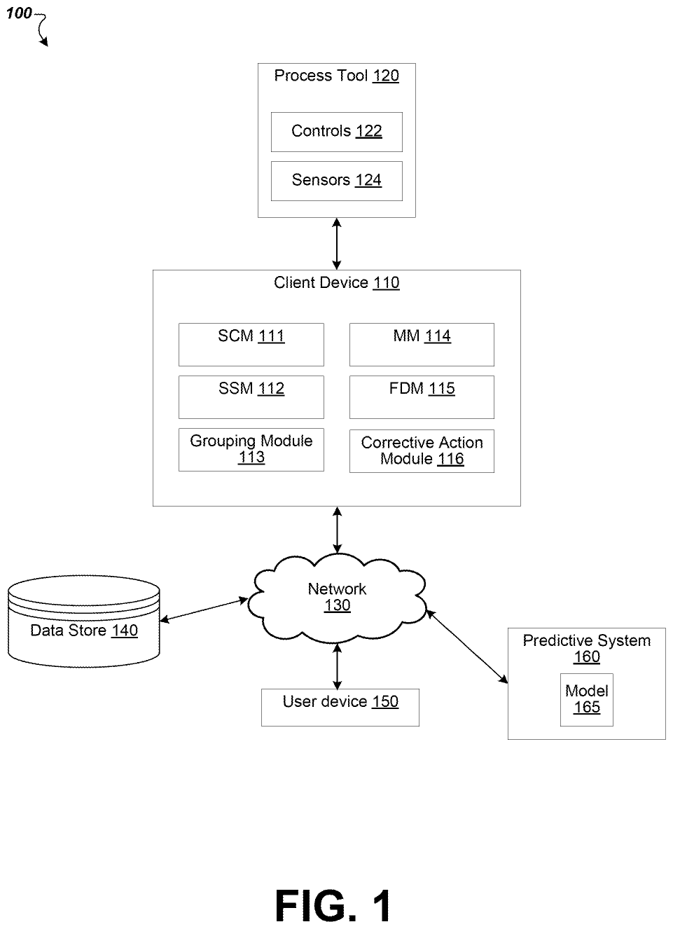

The at least one processing device can cause the corrective action to be provided. In some implementations, causing the corrective action to be provided includes generating a message identifying the corrective action to address the issue that caused the failure of the process tool, and sending the message to a user device. In some implementations, causing the corrective action to be provided can include causing the corrective action to be provided to address the issue that caused the failure of the process tool without additional user interaction. For example, the at least one processing device can cause a robot to implement the corrective action. Further details regarding implementing autonomous root cause diagnostics for manufacturing systems by analyzing process runs will be described in further detail below with reference to FIGS. 1-7.

Aspects of the present disclosure result in technological advantages that can improve the accuracy of manufacturing system failure diagnosis techniques.

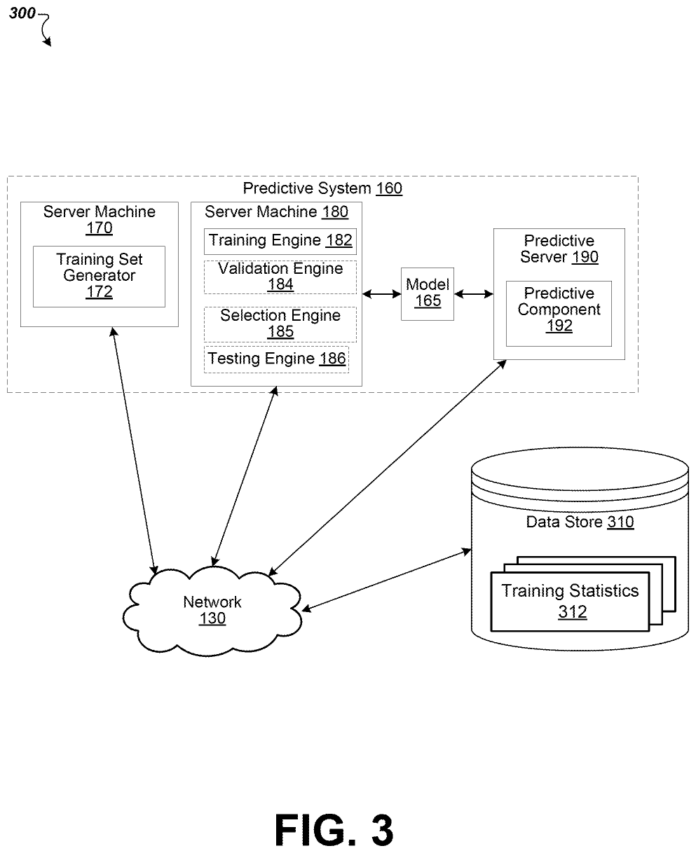

FIG. 1 depicts an illustrative manufacturing system 100, according to aspects of the present disclosure. In some implementations, manufacturing system 100 can be included as part of a manufacturing system for processing substrates. Manufacturing system 100 can include client device 110, process tool 120, network 130, data store 140, user device 150, and predictive system 160 (e.g., to generate predictive data, to provide model adaptation, to use a knowledge base, etc., which will be described in detail in FIG. 3). Process tool 120 can include sensors 124 configured to capture data for a substrate being processed at the manufacturing system. In some implementations, the process tool 120 and sensors 124 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some implementations, metrology equipment can be part of manufacturing system 100 that includes a metrology server (e.g., a metrology database, metrology folders, etc.) and metrology identifier reader (e.g., FOUP RFID reader for metrology system).

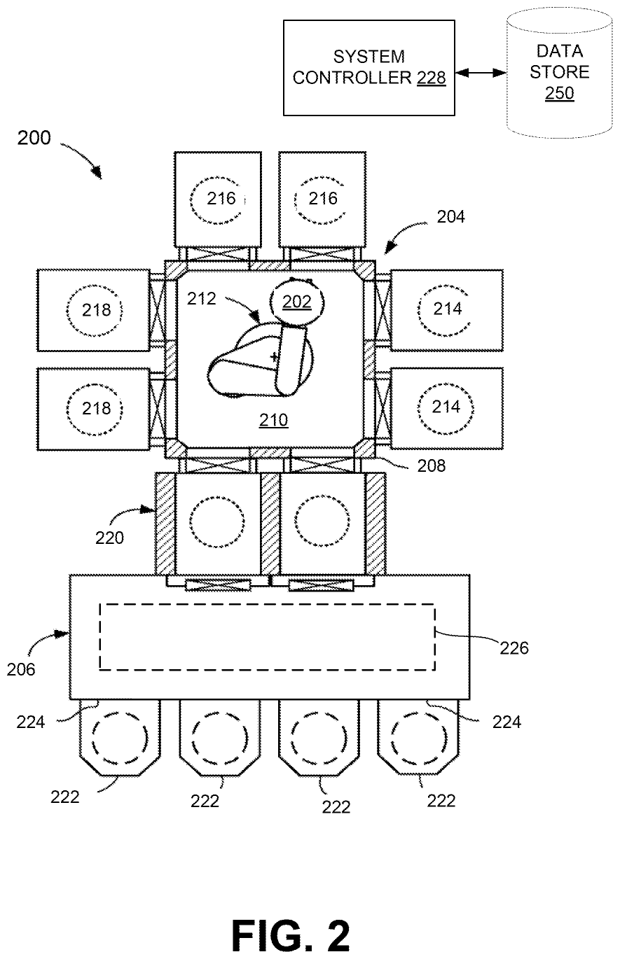

Process tool 120 can produce products, such as electronic devices, following a recipe or performing runs over a period of time. Process tool 120 can include one or more processing chambers, as described in further detail below with reference to FIG. 2. Process tool 120 can use one or more processes to process a substrate (e.g., a wafer) via the one or more processing chambers. Examples of processes that can be used to process a substrate include a deposition process to deposit one or more layers of film on a surface of the substrate, an etch process to form a pattern on the surface of the substrate, etc. Process tool 120 can perform each process according to a process recipe. A process recipe defines a particular set of operations to be performed for the substrate during the process and can include one or more settings associated with each operation. For example, a deposition process recipe can include a temperature setting for the processing chamber, a pressure setting for the processing chamber, a flow rate setting for a precursor for a material included in the film deposited on the substrate surface, etc.

In some implementations, process tool 120 includes controls 122. Controls 122 can include one or more components or sub-systems configured to enable and/or control one or more processes of process tool 120. For example, a sub-system can include a pressure sub-system, a flow sub-system, a temperature sub-system and so forth, each sub-system having one or more components. The component can include, for example, a pressure pump, a vacuum, a gas deliver line, a plasma etcher, actuators etc. In some implementations, controls 122 can be managed based on data from sensors 124.

In some implementations, process tool 120 includes sensors 124 that are configured to generate data associated with a substrate processed at manufacturing system 100. For example, a processing chamber can include one or more sensors configured to generate spectral or non-spectral data associated with the substrate before, during, and/or after a process (e.g., a deposition process, an etch process, etc.) is performed for the substrate. In some implementations, spectral data generated by sensors 124 can indicate a concentration of one or more materials deposited on a surface of a substrate. Sensors 124 configured to generate spectral data associated with a substrate can include reflectometry sensors, ellipsometry sensors, thermal spectra sensors, capacitive sensors, and so forth. Sensors 124 configured to generate non-spectral data associated with a substrate can include temperature sensors, pressure sensors, flow rate sensors, voltage sensors, etc. For example, each sensor 124 can be a temperature sensor, a pressure sensor, a chemical detection sensor, a chemical composition sensor, a gas flow sensor, a motion sensor, a position sensor, an optical sensor, or any and other type of sensors. Some or all of sensors 124 can include a light source to produce light (or any other electromagnetic radiation), direct it towards a target, such as a component of manufacturing system 100 or a substrate, a film deposited on the substrate, etc., and detect light reflected from the target. Sensors 124 can be located anywhere inside process tool 120 (for example, within any processing chamber, loading station, robot, between processing chambers, and so one), or even outside of process tool 120 (e.g., to test ambient temperature, pressure, gas concentration, and so on).

In some implementations, sensors 124 provide sensor data (e.g., sensor values, features, trace data) associated with process tool 120 (e.g., associated with producing, by process tool 120, corresponding products, such as substrates). Process tool 120 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 124 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of process tool 120, or process parameters of process tool 120. The sensor data can be provided while process tool 120 is performing manufacturing processes (e.g., equipment readings when processing products). The sensor data can be different for each substrate.

In some implementations, certain sensors 124 and controls 122 can be related to one or more control modules. In particular, each control module can include a set of sensors 124, controls 122, control logic regulating the sensors and/or components, etc. In an illustrative example, the controls modules can include a thermal control module, a plasma control module, a reactant flux control module, and a substrate control module. The thermal control module can include sensors and controls related to providing and maintain a heating environment in a processing chamber (e.g., heater, heater sensor, etc.). The plasma control module can include sensors and controls related to creating or adjusting a plasma environment in a processing chamber (e.g., plasma etcher, etcher sensor, etc.). The reactant flux control module can include sensors and controls related to the gas flow operations in a processing chamber (e.g., gas flow control and sensor, pump, etc.). The substrate control module can include sensors and controls related to substrate properties (e.g., warp experience by a substrate). In certain implementations, sensor data from one or more of the particular control modules can be processed and analyzed, via modules 111-116 and the methods discussed herein, to control the respective operating conditions (e.g., a parameter of a process recipe) associated with said process control module. Further details regarding process tool 120 are described below with respect to FIG. 2.

Client device 110 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some implementations, the sensor data (or other data items) can be received from the client device 110. Client device 110 can display a graphical user interface (GUI), where the GUI enables the user to provide, as input, metrology measurement values for substrates processed at the manufacturing system. The client device 110 can include sensor control module (SCM) 111, sensor statistic module (SSM) 112, grouping module 113, monitoring module 114, fault detection module (FDM) 115, and corrective action module 116.

SCM 111 can activate sensors, deactivate sensors, place sensors in an idle state, change settings of the sensors, detect sensor hardware or software problems, and so on. In some implementations, SCM 111 can keep track of the processing operations performed by process tool 120 and determine what sensor data is to be sampled for a particular processing (or diagnostic, maintenance, etc.) operation of process tool 120. For example, during a chemical deposition step inside one of the processing chambers, SCM 111 can sample sensors 124 that are located inside the respective processing chamber but not activate (or sample) sensors 124 located inside the transfer chamber and/or the loading station. The raw data obtained by SCM 111 can include time series data where a specific sensor of sensors 124 captures or generates one or more readings of a detected quantity at a series of times. For example, a pressure sensor can generate N pressure readings P(tᵢ) at time instances t₁, t₂, . . . t_{N}. In some implementations, the raw data obtained by SCM 111 can include spatial maps at a pre-determined set of spatial locations. For example, an optical reflectivity sensor can determine reflectivity of a film deposited on the surface of a wafer, R(xⱼ, yₗ), at a set (e.g., a two-dimensional set) of spatial locations xⱼ, yₖ, on the surface of the film/wafer. In some implementations, both the time series and the spatial maps raw data can be collected. For example, as the film is being deposited on the wafer, SCM 111 can collect the reflectivity data from various locations on the surface of the film and at a set of consecutive instances of time, R(tᵢ, xⱼ, yₗ).

SSM 112 can process the raw data obtained by SCM 111 from sensors 124 and determine statistics representative of the raw data (referred to as “statistics data”). For example, for each or some of the raw sensor data distributions, SSM 112 can determine one or more parameters of the distribution, such as a mean, a median, a mode, an upper bound, a lower bound, a variance (or a standard deviation), a skewness (third moment), a kurtosis (fourth moment), or any further moments or cumulants of the data distribution. In some implementations, SSM 112 can model (e.g., via regression analysis fitting) the raw data with various model distributions (normal distribution, log-normal distribution, binomial distribution, Poisson distribution, Gamma distribution, or any other distribution. In such implementations, the one or more parameters can include an identification of the fitting distribution being used together with the fitting parameters determined by SSM 112. In some implementations, SSM 112 can use multiple distributions to fit the raw data from one sensor, e.g., a main distribution and a tail distribution for outlier data points. The parameters of the distributions obtained by SSM 112 can be sensor-specific. For example, for some sensors a small number of parameters can be determined (mean, median, variance) whereas for some sensor many more (e.g., 10 or 20) moments can be determined.

Grouping module 113 can be configured to sort or categorize, into one or more groups, one or more sensors related to the manufacturing process or process tool 120. In some implementations, grouping module can use the sensor data obtained from SCM 111, SSM 112, or any other module or data store that include raw or proceed sensor data. Each group can be defined by certain properties or characteristics of the sensors or the data generated by the sensors. For example, the groups can be defined based on sensor settings, sensor output data types, sensor quality, the sub-system the sensor is correlated to (e.g., flow sub-system, temperature sub-system, pressure sub-system, etc.), etc. The sensor can be grouped from one of more processing chambers of process tool 120, or from processing chambers of multiple manufacturing equipment.

In some implementations, one or more sensors can be categorized into a setpoint group, a tool-life dependent group, or a variability group. The setpoint group can include sensors whose output includes or is expected to include a tight distribution of data over time (e.g., little or no fluctuation of output values over time or over the lifetime of the tool, referred to as tool-life). For example, setpoint sensors can include temperature sensors, radio-frequency power sensors, gas flow sensors, etc. In some implementations, the tight distribution of data can be correlated to the expected results of a process recipe. For example, during the manufacturing process, the processing chamber temperature can be expected to be a constant value. Thus, a deviation from the expected value or predefined limits of the expected value can be flagged as a fault by, for example, FDM 115.

In some implementations, one or more sensors can be categorized into a tool-life dependent group. The tool-life dependent group can include sensors whose output value drifts or changes with time or during the lifetime of the tool. The drift or change can result due to, for example, deterioration of the processing chamber and/or components of the processing chamber, corrosion, erosion, variation of processing chamber coating or conditioning, radio-frequency output time, processing chamber emissivity, component life (e.g., life-time of a heater component), etc. In an example, the sensors categorized into the tool-life dependent group can include heater output value, foreline pressure, radio-frequency impedance, etch rate, etc.

In some implementations, one or more sensors can be categorized into a variability group. The variability group can include sensors that include spikes in output data, sensors that generate inconsistent or asymmetric data, etc. In some implementations, the variability group can include sensors that are not part of the setpoint group (thus do not have a tight distribution) nor part of the tool-life dependent group (thus do not experience a drift that correlates to time or tool-life). In some examples, sensors that are categorized into the variability group can include reflected power sensors, backside flow sensors, sensors that produce relatively significant noise, whose output value changes over time but is not correlated with the tool-life, those that have no effect on a tool, etc.

Although implementations of the present disclosure will be discussed in relation to sensor groups, in some implementations, grouping module 113 can be configured to organize, into one or more groups, one or more data items. A data item can include sensor data, task data, contextual data, statistics data, etc. In some implementations, the data items can first be combined into a set(s) of “arrays.” An array can include a combination of data items according to a predefined format or pattern. In some implementations, each array can include a particular sensor (e.g., chamber pressure sensor, heater current sensor, etc.), a statistic data type (e.g., mean, range, etc.), and a recipe portion identifier (e.g., step one, step five, entire recipe, etc.). For example, an array can be indicative of the average heater voltage during step three of a particular process recipe.

In some implementations, grouping module 113 can categorize sensors into one or more specific groups. In some implementations, grouping module 113 can use a detection method to categorize sensors into one or more specific groups. The detection method can be configured to correlate each sensor to one or more predefined groups based on one or more predefined criterion. In an implementation, the detections method can first implement a distribution method (e.g., a Gaussian distribution method, or any other method capable of determining deviations in datasets) to generate distributions, for each sensor, based on time and tool-life.

The detection method can then calculate coefficients of variations and correlations for both distributions (e.g., the distribution based on time and the distribution based on tool-life. The coefficient of variation (CV) is the ratio of the standard deviation to the mean and shows the extent of variability in relation to the mean of the population. In one example, the coefficient of variation can be determined by dividing a population standard deviation by the population mean. A correlation coefficient is a number between −1 and 1 that indicates the strength and direction of a relationship between variables (e.g., a statistical relationship between two variables). In particular, the correlation method can be configured to identify pairings between corresponding output value of both distributions.

In some implementations, the correlation method can include a clustering method that can receive, as input data, the corresponding sensor value from both distributions, and generate, as output data, the indications of correlations. In some embodiments, grouping module 113 can generate the output data using, for example, a clustering method. Clustering methods can include a K-means clustering method, a density-based spatial clustering of applications with noise (SBSCAN) method, a Spectral Clustering method, a Ward clustering method, a Birch clustering method, or any other clustering method.

Responsive to coefficients of variations satisfying a setpoint criterion (e.g., the coefficients of variations are below a threshold value and the correlations are within a certain range to the value 1), grouping module 113 can categorize those sensors as setpoint sensors. Responsive to coefficients of variations satisfying a tool-life dependent criterion (e.g., the coefficients of variations are above a threshold value and the correlation of the tool life data across multiple processing chambers is within a certain range to the value 1), grouping module 113 can categorize those sensors as tool-life dependent sensors. Responsive to neither the setpoint criterion nor the tool-life dependent criterions being satisfied, grouping module 113 can then categorize those sensors as variability sensor.

In some implementations, grouping module 113 can use one or more machine learning models (e.g., machine learning model (“model”) 165) to categorize sensors into one or more specific groups. In particular, grouping module 113 can input sensor data (e.g., sensor values, sensor characteristic data, etc.) into the machine learning model, and receive, as output, data indicative of group assignments (e.g., to which group each sensor should be assigned). The machine learning model can be generated by predictive system 160, which is discussed with regards to FIG. 3.

In some implementations, grouping module 113 can use a sensor ranking method. The sensor ranking method can group sensors based on each sensor's method or significance. The importance or significance of each sensor can be determined by comparing the value from similar or the same sensor during different process runs, from different processing chambers, from good process runs (e.g., where the substrate is fabricated exactly or close to desired specifications, versus where the substrate is fabricated with defects or deformations), etc. In an illustrative example, grouping module 113 can monitor a set of process runs of a process recipe to collect runtime data from a set of sensors of process tool 120. Grouping module 113 can determine qualitative data describing each of the substrates produced by the set of process runs of the process recipe. Grouping module 113 can characterize each of the process runs into a respective, predetermined group based on an analysis of the qualitative data. Grouping module 113 can then generate a data model, based on the collected runtime data, which describes, for each of the plurality of groups, at least one of the patterns of sensor data for the respective group and/or a relative importance of each of a set of sensor types of the set of sensors in indicating the respective group. In some implementations, grouping module 113 can perform a multivariate analysis of additional runtime data collected during at least one subsequent run of the recipe within the manufacturing environment to classify the at least one subsequent run into one of the of the groups, by determining which pattern of sensor data specified within the data model best fits the additional runtime data. Upon classifying the at least one subsequent run of the recipe into the particular group, grouping module 113 can generate an output (e.g., for display on an interface of client device 110) depicting a ranking of at least two of the sensor types based on the additional runtime data and the description of relative importance of each of the plurality of sensor types for the particular group within the data mode.

Monitoring module 114 can generate one or more graphical user interfaces (GUI) to monitor the one or more sensor groups. In some implementations, monitoring module 114 can generate a health index GUI configured to track the output data generated by the sensors of one or more sensor groups. The health index GUI can display each sensor of one or more sensor groups (or a subset of sensors from one or more sensor groups) and their respective output values over a timeline (e.g., a time, a number of process runs, etc.). In some implementations, for one or more of the displayed sensors, one or more limits can be displayed. The limits can be indicative of a deviation, a fault, an anomaly, or any other indication of abnormal or irregular data. In some implementation, the limit may be related to a fault detection limit, which is discussed below. In an illustrative example, in instances where the sensor values exceed the limit values, monitoring module 114 can generate an alert (e.g., display or send a prompt, generate a sound, etc.). In some implementations, in response to a sensor value exceeding a limit value, a corrective action, via corrective action module 116, can be performed. In some implementations, monitoring module 114 can generate a heat map configured to track the output data generated by the sensors of one or more sensor groups.

FDM 115 can process, aggregate, and analyze data collected by SCM module 111, SSM 112, and/or grouping module 113. In particular, FDM 115 can automatically aggregate and normalize sensor data to generate fault detection limits. A fault detection limit can be an indicator that a sensor's output data is indicative of a fault or anomaly. In some implementation, multiple fault detection limits can be used. For example, a first fault detection limit can reflect a “caution” limit (or fault), which is indicative of data being outside normal range, but not within a range that can cause abnormalities to the substrate. A second fault detection limit can reflect a critical limit (or fault), which is indicative of potential damage occurring during the manufacturing process.

In some implementations, data from a particular type of sensor (from one or more processing chambers) can be aggregated and normalized. For example, for each processing chamber, heater output data can be obtained, aggregated, and normalized. In some implementations, FDM 115 can aggregate and normalize data for each type of sensor categorized into a group.

In some implementations, to aggregate and normalize the sensor data, FDM 115 can combine different data sets into a single dataset. FDM 115 can further generate a distribution of the sensor data to identify or generate one or more fault detection limits. For example, the distribution of the sensor data can be a normal or gaussian distribution. FDM 115 can then identify a normal data range and set one or more fault detection limits. In one example, the fault detection limits can be based on standard deviations of the data distribution. For example, FDM 115 can determine the mean value of the aggregated dataset and identify the sensor output values within the first standard deviation of the mean value, identify the sensor values between the first standard deviation and the second standard deviation, and so forth. Each standard deviation range can be related to a fault detection limit. For example, sensor data within the first standard deviation can be identified as normal sensor data. The first standard deviation can be set as the first fault detection limit, and sensor data between the first and second standard deviation can be identified “caution,” sensor data. The second standard deviation can be set as the second fault detection limit, and sensor data between the second and third standard deviation (or outside the second standard deviation) can be identified as “critical” sensor data. In some implementations, the fault detection limits can be set using a training set of data. In some implementations, the fault detection limits can be set and/or adjusted using real-time data. In some implementations, the fault detection limits can be determined using training data comprising ideal or near ideal process runs (e.g., process runs that contain no abnormalities). In some implementations, the groups can be updated based on the data triggering the fault detection limits. For example, during production runs, fault detection module can determine that certain censors deviate past certain fault detection limits (e.g., critical limits). Accordingly, those sensors be categorized as setpoint sensors, and added to the setpoint group. It is noted that the example for aggregating and normalizing the sensor data are used by way of illustrative example, and that other method can be used. In some implementations, FDM 115 can pre-process, reduce the dimensionality of the sensor statistics, process the reduced representations of statistics, normalize, and/or process using a neural network to determine fault detection limits, etc. At least some of the listed operations can include machine learning.

Corrective action module 116 can receive user input (e.g., via a graphical user interface (GUI) displayed via client device 110) of an indication associated with process tool 120. In some implementations, the corrective action module 116 receives input data from FDM 115, determines a corrective action based on the input data, and causes the corrective action to be provided. For example, responsive to receiving an indication that sensor data satisfied a threshold criterion (e.g., exceeded or fell below a fault detection limit), the correction action module 116 can perform one or more corrective actions. The corrective actions can be stored in a fault pattern library on data store 140. In some implementations, corrective action module 116 receives an indication of a corrective action from the predictive system 160 and causes the corrective action to be implemented. Client device 110 can include an operating system that allows a user to, via user device 150, generate, view and/or or edit data (e.g., indication associated with process tool 120, corrective actions associated with process tool 120, etc.).

Although shown as module of client device 110, each module 111-116 can be included in one or more other computing devices, such as a rackmount server, a router computer, a server computer, a personal computer, a mainframe computer, a laptop computer, a tablet computer, a desktop computer, a GPU, an ASIC, etc. Each module 111-116 can execute instructions to perform any one or more of the methodologies and/or implementations described herein. The instructions can be stored on a computer readable storage medium, which can include the main memory, static memory, secondary storage and/or processing device (during execution of the instructions).

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing a substrate at process tool 120. For example, data store 140 can store data collected by sensors 124 at process tool 120 before, during, or after a substrate process (referred to as process data). Process data can refer to historical process data (e.g., process data generated for a prior substrate processed at the manufacturing system) and/or current process data (e.g., process data generated for a current substrate processed at the manufacturing system). Data store can also store spectral data or non-spectral data associated with a portion of a substrate processed at process tool 120. Spectral data can include historical spectral data and/or current spectral data.

Data store 140 can also store contextual data associated with one or more substrates processed at the manufacturing system. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a processing chamber.

Data store 140 can also store task data. Task data can include one or more sets of operations to be performed for the substrate during a deposition process and can include one or more settings associated with each operation. For example, task data for a deposition process can include a temperature setting for a processing chamber, a pressure setting for a processing chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some implementations, data store 140 can store statistics data. Statistics data can include statistics representative of the raw data, generated by SSM 112, e.g., mean data (average), range data, standard deviation data, maximum and minimum data, median data, mode data, etc. Mean data can include a measured averages of two or more values. For example, mean data can be used to determine the average heater temperature, the processing chamber pressure, the average flowrate of a gas, etc., during a step(s), a specific time duration, an entire process recipe, etc. Range data can include the middle observation in a set of data (e.g., a median temperature during a step). Range data can include the difference between a maximum value and a minimum value of a set of values (e.g. the range of the heater pressure during a process recipe). The standard deviation is measure of the amount of variation or dispersion of a set of values.

In some implementations, data store 140 can store sensor group data. Sensor group data can include data identifying to which group a sensor is assigned. For example, a first set of sensors or arrays can be assigned (by grouping module 113) to the setpoint group, a second set of sensors or arrays can be assigned to the tool-life dependent group, etc. In some implementations, the sensor group data can include metadata that is related to each particular sensor. In some implementations, the sensor group data can include a data structure, such as a data table, which stores records, where each record include a sensor identifier and a group identifier.

In some implementations, data store 140 can be configured to store data that is not accessible to a user of the manufacturing system. For example, process data, spectral data, contextual data, etc. obtained for a substrate being processed at the manufacturing system is not accessible to a user (e.g., an operator) of the manufacturing system. In some implementations, all data stored at data store 140 can be inaccessible by the user of the manufacturing system. In other or similar implementations, a portion of data stored at data store 140 can be inaccessible by the user while another portion of data stored at data store 140 can be accessible by the user. In some implementations, one or more portions of data stored at data store 140 can be encrypted using an encryption mechanism that is unknown to the user (e.g., data is encrypted using a private encryption key). In other or similar implementations, data store 140 can include multiple data stores where data that is inaccessible to the user is stored in one or more first data stores and data that is accessible to the user is stored in one or more second data stores.

In some implementations, data store 140 can be configured to store data associated with known fault patterns. A fault pattern can be a one or more values (e.g., a vector, a scalar, etc.) associated with one or more issues or failures associated with a processing chamber sub-system. In some implementations, a fault pattern can be associated with a corrective action. For example, a fault pattern can include parameter adjustment steps to correct the issue or failure indicated by the fault pattern. For example, the predictive system or the corrective action module can compare a determined fault pattern (determined from data obtained from of one or more sensors of a sensor cluster) to a library of known fault patterns to determine the type of failure experienced by a sub-system, the cause of the failure, the recommended corrective action to correct the fault, and so forth.

Client device 110, process tool 120, data store 140, user device 150 and/or predictive system 160 can be coupled to each other via network 130. In some implementations, network 130 is a public network. In some implementations, network 130 is a private network. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

In some implementations, a “user” can be represented as a single individual. However, in other implementations, a “user” is an entity controlled by a plurality of users and/or an automated source. For example, a set of individual users federated as a group of administrators can be considered a “user.”

FIG. 2 is a top schematic view of an example manufacturing system 200, according to aspects of the present disclosure. Manufacturing system 200 can perform one or more processes on a substrate 202. Substrate 202 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 200 can include process tool 204 and a factory interface 206 coupled process tool 204. Process tool 204 can include a housing 208 having a transfer chamber 210 therein. Process tool 204 can include one or more processing chambers, in this example multiple processing chambers 214, 216 and 218, disposed therearound and coupled thereto. Processing chambers 214-218 can be coupled to transfer chamber 210 through respective ports, such as slit valves or the like. Transfer chamber 210 can also include a transfer chamber robot 212 configured to transfer substrate 202 between processing chambers 214-218, load lock 220, etc. Transfer chamber robot 212 can include one or multiple arms where each arm includes one or more end effectors at the end of each arm. The end effector can be configured to handle particular objects, such as wafers, sensor discs, sensor tools, etc.

Processing chambers 214-218 can be adapted to carry out any number of processes on substrates 202. A same or different substrate process can take place in each processing chamber 214-218. A substrate process can include atomic layer deposition (ALD), physical vapor deposition (PVD), chemical vapor deposition (CVD), etching, annealing, curing, pre-cleaning, metal or metal oxide removal, or the like. Other processes can be carried out on substrates therein. One or more sensors can be included on or within at least one of processing chambers 214-218 to capture data for substrate 202 before, after, or during a substrate process. For example, the one or more sensors can be configured to capture spectral data and/or non-spectral data for a portion of substrate 202 during a substrate process. In other or similar implementations, the one or more sensors can be configured to capture data associated with the environment within at least one of processing chambers 214-218 before, after, or during the substrate process. For example, the one or more sensors can be configured to capture data associated with a temperature, a pressure, a gas concentration, etc. of the environment of at least one of processing chambers 214-218 during processing of substrate 202.

In some implementations, metrology equipment (not shown) can be located within process tool 204. In other implementations, metrology equipment (not shown) can be located within at least one of processing chambers 214-218. In some implementations, substrate 202 can be placed onto metrology equipment using transfer chamber robot 212. In other implementations, the metrology equipment can be part of the substrate support assembly (not shown). Metrology equipment can provide metrology data associated substrate 202 processed by process tool 120. The metrology data can include a value of film property data (e.g., wafer spatial film properties), dimensions (e.g., thickness, height, etc.), dielectric constant, dopant concentration, density, defects, etc. In some implementations, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology data can be generated using, for example, reflectometry techniques, ellipsometry techniques, TEM techniques, and so forth.

Load lock 220 can also be coupled to housing 208 and transfer chamber 210. Load lock 220 can be configured to interface with, and be coupled to, transfer chamber 210 on one side and factory interface 206. Load lock 220 can have an environmentally-controlled atmosphere that can be changed from a vacuum environment (wherein substrates can be transferred to and from transfer chamber 210) to an at or near atmospheric-pressure inert-gas environment (wherein substrates can be transferred to and from factory interface 206) in some implementations. Factory interface 206 can be any suitable enclosure, such as, e.g., an Equipment Front End Module (EFEM). Factory interface 206 can be configured to receive substrates 202 from substrate carriers 222 (e.g., Front Opening Unified Pods (FOUPs)) docked at various load ports 224 of factory interface 206. A factory interface robot 226 (shown dotted) can be configured to transfer substrates 202 between carriers (also referred to as containers) 222 and load lock 220. Carriers 222 can be a substrate storage carrier or a replacement part storage carrier.

Manufacturing system 200 can also be connected to a client device (e.g., client device 110 of FIG. 1) that is configured to provide information regarding manufacturing system 200 to a user via a user device (e.g., user device 150 of FIG. 1). For example, the user can be an operator of manufacturing system 200. In some implementations, the client device can provide information to the user via one or more GUIs displayed on the user device. For example, the client device can provide, via a GUI, information regarding a target thickness profile for a film to be deposited on a surface of a substrate 202 during a deposition process performed by at least one of processing chambers 214-218. The client device can also provide information regarding anomaly detection and fault classification, in accordance with implementations described herein.

Manufacturing system 200 can also include a system controller 228. System controller 228 can be and/or include a computing device such as a personal computer, a server computer, a programmable logic controller (PLC), a microcontroller, and so on. System controller 228 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 228 can include a data storage device (e.g., one or more disk drives and/or solid state drives), a main memory, a static memory, a network interface, and/or other components. System controller 228 can execute instructions to perform any one or more of the methodologies and/or implementations described herein. In some implementations, system controller 228 can execute instructions to perform one or more operations at manufacturing system 200 in accordance with a process recipe. The instructions can be stored on a computer readable storage medium, which can include the main memory, static memory, secondary storage and/or processing device (during execution of the instructions).

System controller 228 can receive data from sensors (e.g., sensors 124 of FIG. 1) included on or within various portions of manufacturing system 200 (e.g., at least one of processing chambers 214-218, transfer chamber 210, load lock 220, or robot 212). In some implementations, data received by the system controller 228 can include spectral data and/or non-spectral data for a portion of substrate 202. In other or similar implementations, data received by the system controller 228 can include data associated with processing substrate 202 using at least one of processing chambers 214-218, as described previously. In an illustrative example, system controller 228 can receive data from one or more sensors included on or within at least one of processing chambers 214-218 before, after, or during a substrate process performed by at least one processing chambers 214-218. Data received from sensors of the various portions of manufacturing system 200 can be stored in a data store 250. Data store 250 can be included as a component within system controller 228 or can be a separate component from system controller 228. In some implementations, data store 250 can be data store 140 described with respect to FIG. 1.

FIG. 3 depicts an illustrative predictive architecture 300, according to aspects of the present disclosure. In some implementations, predictive architecture 300 include predictive system 160, network 130, and data store 310 (e.g., data store 140 of FIG. 1). In some implementations, predictive system 160 can use a model (e.g., model 165 of FIG. 1) to group two or more sensor based on, for example, sensor statistics data. For example, model 165 can received sensor statistics data as input, and generate, as output, sensor cluster data. In some implementations, predictive system 160 can include predictive server 112, server machines 170 and 180, and predictive server 190. The predictive server 160, server machine 170, server machine 180, and predictive server 190 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Server machine 170 includes a training set generator 172 that is capable of generating training data sets (e.g., a set of data inputs and a set of target outputs) to train, validate, and/or test a machine learning model 165. Machine learning model 165 can be any model capable of learning from data. In some implementations, machine learning model 165 can be a predictive model. In some implementations, the data set generator 172 can partition the training data into a training set, a validating set, and a testing set, which can be stored, as part of the training statistics 312, in the training data store 310. Training statistics 312 which can be accessible to the computing device predictive system 160 directly or via network 130. In some implementations, the predictive system 160 generates multiple sets of training data.

Server machine 180 can include a training engine 182, a validation engine 184, a selection engine 185, and/or a testing engine 186. An engine can refer to hardware (e.g., circuitry, dedicated logic, programmable logic, microcode, processing device, etc.), software (such as instructions run on a processing device, a general-purpose computer system, or a dedicated machine), firmware, microcode, or a combination thereof. Training engine 182 can be capable of training one or more machine learning model 165. Machine learning model 165 can refer to the model artifact that is created by the training engine 182 using the training data (also referred to herein as a training set) that includes training inputs and corresponding target outputs (correct answers for respective training inputs). The training engine 182 can find patterns in the training data that map the training input to the target output (the answer to be predicted), and provide the machine learning model 165 that captures these patterns. Model 165 can use one or more of a statistical modeling, support vector machine (SVM), Radial Basis Function (RBF), clustering, supervised machine learning, semi-supervised machine learning, unsupervised machine learning, k-nearest neighbor method (k-NN), linear regression, random forest, neural network (e.g., artificial neural network), etc.

One type of machine learning model that can be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g. classification outputs). Deep learning is a class of machine learning methods that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In a plasma process tuning, for example, the raw input can be process result profiles (e.g., thickness profiles indicative of one or more thickness values across a surface of a substrate); the second layer can compose feature data associated with a status of one or more zones of controlled elements of a plasma process system (e.g., orientation of zones, plasma exposure duration, etc.); the third layer can include a starting recipe (e.g., a recipe used as a starting point for determining an updated process recipe the process a substrate to generate a process result the meets threshold criteria). Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

In one implementation, one or more machine learning model is a recurrent neural network (RNN). An RNN is a type of neural network that includes a memory to enable the neural network to capture temporal dependencies. An RNN is able to learn input-output mappings that depend on both a current input and past inputs. The RNN will address past and future flow rate measurements and make predictions based on this continuous metrology information. RNNs can be trained using a training dataset to generate a fixed number of outputs (e.g., to determine a set of substrate processing rates, determine modification to a substrate process recipe). One type of RNN that can be used is a long short term memory (LSTM) neural network.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

A training dataset containing hundreds, thousands, tens of thousands, hundreds of thousands or more sensor data and/or process result data (e.g., metrology data such as one or more thickness profiles associated with the sensor data) can be used to form a training dataset.

To effectuate training, processing logic can input the training dataset(s) into one or more untrained machine learning models. Prior to inputting a first input into a machine learning model, the machine learning model can be initialized. Processing logic trains the untrained machine learning model(s) based on the training dataset(s) to generate one or more trained machine learning models that perform various operations as set forth above. Training can be performed by inputting one or more of the sensor data into the machine learning model one at a time.

The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine learning model can produce.

Accordingly, the output can include one or more predictions or inferences. In some implementations, an output prediction or inference can include one or more predictions of sensor group classifications, sensor rankings, etc. In some implementations, an output prediction or inference can include one or more predictions of anomaly data, fault data, fault detection limits, etc. Processing logic determines an error (i.e., a classification error) based on the differences between the output (e.g., predictions or inferences) of the machine learning model and target labels associated with the input training data. Processing logic adjusts weights of one or more nodes in the machine learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one implementation, the stopping criteria is met when at least a minimum number of data points have been processed and at least a threshold accuracy is achieved. The threshold accuracy can be, for example, 70%, 80% or 90% accuracy. In one implementation, the stopping criterion is met if accuracy of the machine learning model has stopped improving. If the stopping criterion has not been met, further training is performed. If the stopping criterion has been met, training can be complete. Once the machine learning model is trained, a reserved portion of the training dataset can be used to test the model.

Once one or more trained machine learning models 190 are generated, they can be stored in predictive server 190 as predictive component 192 or as a subcomponent of predictive component 192.

Validation engine 184 can be capable of validating machine learning model 165 using a corresponding set of features of a validation set from training set generator 172. Once the model parameters have been optimized, model validation can be performed to determine whether the model has improved and to determine a current accuracy of the deep learning model. Validation engine 184 can determine an accuracy of machine learning model 165 based on the corresponding sets of features of the validation set. Validation engine 184 can discard a trained machine learning model 165 that has an accuracy that does not meet a threshold accuracy. In some implementations, selection engine 185 can select model 165 as a trained machine learning model that has an accuracy that meets a threshold accuracy. In some implementations, selection engine 185 can be capable of selecting model 165 as a trained machine learning model that has the highest accuracy among a set of trained machine learning models.

Testing engine 186 can be capable of testing model 165 using a corresponding set of features of a testing set from data set generator 172. For example, model 165 can be tested using a set of features of the testing set. The testing engine 186 can determine that model 165 that has the highest accuracy of all of the trained machine learning models based on the testing sets.

Predictive server 190 can include predictive component 192 that use model 165 on input data (e.g., sensor data or statistics data) to infer one or more outputs. Predictive server 190 can further provide fault detection data and/or anomaly detection data.

It should be noted that in some other implementations, the functions of server machines 170 and 180, as well as predictive server 190, can be provided by a fewer number of machines. For example, in some implementations, server machines 170 and 180 can be integrated into a single machine, while in some other or similar implementations, server machines 170 and 180, as well as predictive server 190, can be integrated into a single machine.

In general, functions described in one implementation as being performed by server machine 170, server machine 180, and/or predictive server 190 can also be performed on client device 110. In addition, the functionality attributed to a particular component can be performed by different or multiple components operating together.

In some implementations, a manufacturing system can include a process tool having multiple process chambers. In some implementations, data obtained to train model 165 and data collected to be provided as input to model 165 are associated with the same processing chamber of the manufacturing system. In some implementations, data obtained to train model 165 and data collected to be provided as input to model 165 are associated with different processing chambers of the manufacturing system. In some implementations, data obtained to train model 165 can be associated with a first processing chamber of a first manufacturing system and data collected to be provide as input to the machine learning model can be associated with a second processing chamber of a second manufacturing system different from the first manufacturing system.

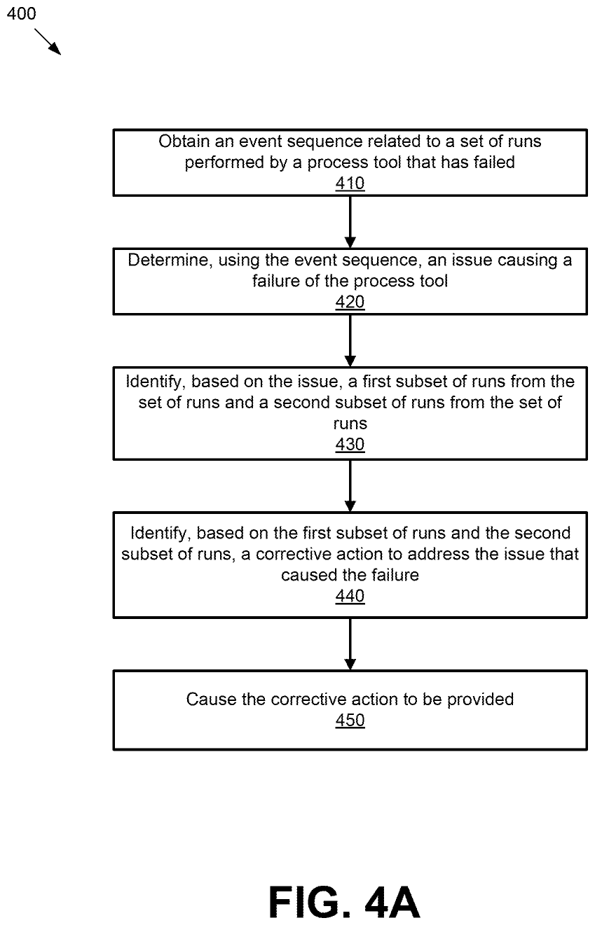

FIG. 4A is a flow chart of a method 400 for implementing autonomous root cause diagnostics for manufacturing systems by analyzing process runs, in accordance with some implementations of the present disclosure. Method 400 is performed by processing logic that can include hardware (circuitry, dedicated logic, etc.), software (such as is run on a general-purpose computer system or a dedicated machine), firmware, or some combination thereof. In one implementation, method 400 can be performed by a computer system, such as manufacturing system 100 of FIG. 1. In other or similar implementations, one or more operations of method 400 can be performed by one or more other machines not depicted in the figures. In some aspects, one or more operations of method 400 can be performed by client device 110, predictive system 160, server machine 170, server machine 180, and/or predictive server 190.

At operation 410, processing logic obtains an event sequence related to a set of runs performed by a process tool that has a failure. The process tool can be included in a manufacturing system. In some embodiments, the manufacturing system is an electronic device processing system (e.g., a semiconductor device processing system). For example, the process tool can include a set of processing chambers (e.g., one or more processing chambers). Each run can be performed in accordance with a process recipe.

The event sequence can include data indicative of a set of events that resulted from the set of runs. In some implementations, each event of the set of events is represented by an event code defined for the event. Examples of events and associated codes (in parentheses) include normal process run (p), qualification run for film thickness (QT), qualification run for film defects (QD), tool is down (TD), scheduled downtime (SD), tool alarm (TA), other issue (other), etc. In some implementations, obtaining the event sequence includes receiving raw event sequence data related to the set of runs, and generating the event sequence by processing the raw event sequence data. For example, generating the event sequence includes assigning event codes to the raw event sequence data.

At operation 420, processing logic determines, using the event sequence, an issue causing the failure of the process tool. Examples of issues include defect issues, uniformity issues, yield issues, etc. An issue can correspond to at least one fault pattern. For example, a defect issue can correspond to a fault pattern {QD, QD, TD}. As another example, a uniformity issue can correspond to a fault pattern {QT, QT, TD}. As yet another example, a yield issue can correspond to a fault pattern {p, p, TD}.

In some implementations, determining the issue includes comparing the event sequence to a set of predefined fault patterns to identify a fault pattern corresponding to the issue. More specifically, the set of predefined fault patterns can be stored in a data store (e.g., database). For example, the data store can be similar to data store 140 of FIG. 1. Determining the issue can include performing pattern matching. For example, a predefined fault pattern can be {QD, QD, TD}, which can be defined in the data store as a defect issue. If the event sequence includes the fault pattern {QD, QD, TD}, then the at least one processing device can determine that the issue is a defect issue based on a comparison of the event sequence to the predefined fault patterns, including {QD, QD, TD}, maintained in the data store.

In some implementations, determining the issue includes using a machine learning model (e.g., at least one neural network) trained to infer the issue from the event sequence. For example, the machine learning model can be trained to perform pattern recognition to match the event sequence to an issue based on a fault pattern. Illustratively, if the event sequence includes the fault pattern {QT, QT, TD}, then at least one processing device can use the machine learning model to infer that the issue is a uniformity issue.

At operation 430, processing logic identifies, based on the issue, a first subset of runs from the set of runs and a second subset of runs from the set of runs. In some implementations, identifying the first subset of runs and the second subset of runs includes generating at least one of the first subset of runs or the second subset of runs. In some implementations, the first subset of runs defines a set of bad runs identified in the set of runs and the second subset of runs defines a set of good runs identified in the set of runs. For example, assume that an event sequence includes {QD, p, p, QD, p, p, p, p, QD, QD, TD}, and that the issue is a defect issue (e.g., based on the fault pattern {QD, QD, TD} as described above). The first subset of runs (e.g., set of bad runs) can include the QDs of the fault pattern {QD, QD, TD}, and the second subset of runs (e.g., set of good runs) can include the other QDs of the event sequence.

At operation 440, processing logic identifies, based on the first subset of runs the second subset of runs, a corrective action to address the issue that caused the failure. In some implementations, and as will be described in further detail below with reference to FIG. 4B, identifying the corrective action can include analyzing first sensor data (e.g., sensor trace data) from the first subset of runs and second sensor data (e.g., sensor trace data) from the second subset of runs to identify a set of sensors, determining a root cause of the issue from the set of sensors, and determining the corrective action from the root cause.

At operation 450, processing logic causes the corrective action to be provided. In some implementations, causing the corrective action to be provided includes causing the corrective action to be displayed on a user device via a graphical user interface (GUI). In some implementations, causing the corrective action to be provided includes generating a message (e.g., alert) identifying the corrective action to address the issue that caused the failure of the process tool, and sending the message to a user device. The user can then perform the corrective action that was identified (e.g., via the GUI and/or the message).

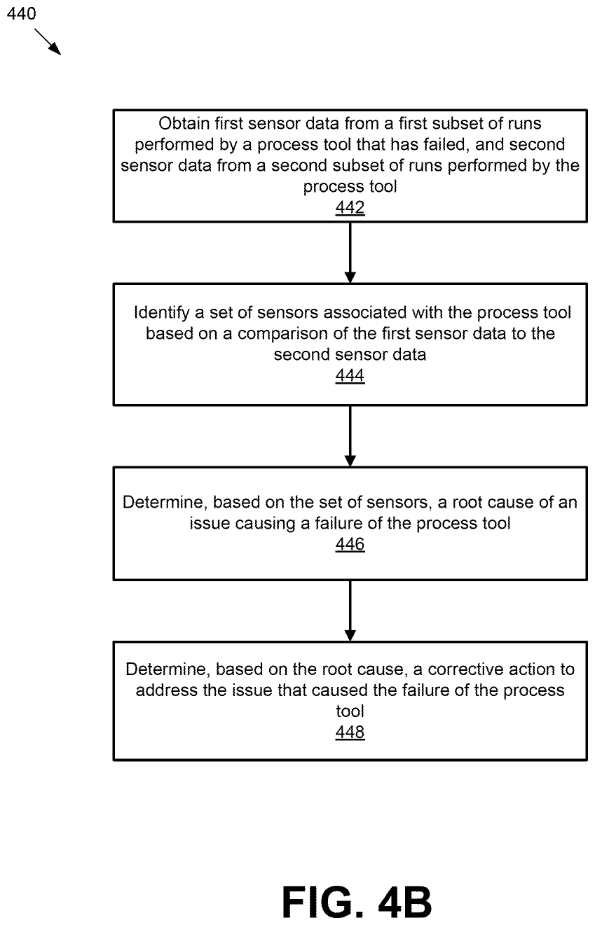

In some implementations, causing the corrective action to be provided can include causing the corrective action to be provided to address the issue that caused the failure of the process tool without additional user interaction. For example, the at least one processing device can cause a robot to implement the corrective action. Further details regarding operations 410-450 will now be described below with reference to FIG. 4B. In some implementations, and as will be described in further detail below with reference to FIG. 5, processing logic can receive feedback data indicating whether the corrective action was successful in addressing the issue causing the failure of the process tool, and use the feedback data to optimize how the corrective action determination is made in the future.

FIG. 4B is a flow chart of a method 440 for identifying a corrective action to address an issue that caused a failure of a process tool, in accordance with some implementations of the present disclosure. Method 440 is performed by processing logic that can include hardware (circuitry, dedicated logic, etc.), software (such as is run on a general-purpose computer system or a dedicated machine), firmware, or some combination thereof. In one implementation, method 440 can be performed by a computer system, such as manufacturing system 100 of FIG. 1. In other or similar implementations, one or more operations of method 440 can be performed by one or more other machines not depicted in the figures. In some aspects, one or more operations of method 440 can be performed by client device 110, predictive system 160, server machine 170, server machine 180, and/or predictive server 190.

At operation 442, processing logic obtains first sensor data from a first subset of runs performed by a process tool that has failed, and second sensor data from a second subset of runs performed by the process tool. In some implementations, the first subset of runs is a set of bad runs performed by the process tool, and the second subset of runs is a set of good runs performed by the process tool, as described above with reference to FIG. 4A. In some implementations, the first sensor data and the second sensor data each include respective sensor trace data.

At operation 444, processing logic identifies a set of sensors associated with the process tool based on a comparison of the first sensor data to the second sensor data. More specifically, the comparison of the first sensor data to the second sensor data can identify one or more sensors that show a difference in sensor behavior, where the one or more sensors define the set of sensors. Identifying the set of sensors can further include ranking the one or more sensors to generate the set of sensors as a ranked set of sensors. For example, the ranking can be performed based on difference magnitude in sensor behavior (e.g., in descending order with the sensor having the greatest difference in magnitude being the top ranked sensor). Additionally or alternatively, the ranking can be based on the frequency of identification of the sensors in previous failures (e.g., in descending order with the sensor that has been most frequently identified in previous failures being the top ranked sensor). Other ranking methods are contemplated.

At operation 446, processing logic determines, based on the set of sensors, a root cause of an issue causing a failure of the process tool. The root cause can be identified from the set of sensors using any suitable technique. In some implementations, determining the root cause includes identifying the root cause using information mapping the set of sensors to the root cause in a data store (e.g., data store 140 of FIG. 1 and/or the data store described above with reference to FIG. 4A). That is, the information can be predefined in the data store. In some implementations, determining the root cause includes using a machine learning model trained to infer the root cause from data representing the set of sensors. For example, the machine learning model can be trained to perform pattern recognition to match the data representing the set of sensors to a root cause based on a sensor pattern.

At operation 448, processing logic determine, based on the root cause, a corrective action to address the issue that caused the failure of the process tool. In some implementations, identifying the corrective action includes identifying the corrective action using information mapping the root cause to the corrective action a data store (e.g., data store 140 of FIG. 1 and/or the data store described above with reference to FIG. 4A). That is, the information can be predefined in the data store. In some implementations, identifying the corrective action includes using a machine learning model trained to infer the corrective action from the root cause.

Illustratively, assume that the issue is a defect issue and the set of sensors identified at operation 444 includes a pressure sensor, a flow sensor, a temperature sensor and an RF bias sensor, arranged in that order. The pressure sensor and the flow sensor being the top ranked sensors can indicate that root cause of the defect issue is a foreline clog causing pressure fluctuation (e.g., from the data store or by using the machine learning model). The corrective action to address the foreline clog, and thus address the defect issue, can be clean the foreline. The corrective action can be provided as a message to a user identifying that the issue can be addressed by cleaning the foreline. Alternatively, the corrective action can be provided without additional user interaction by causing a robot to clean the foreline.

FIG. 5 is a flow chart of a method 500 for optimizing autonomous root cause diagnostics for manufacturing systems by analyzing process runs, in accordance with some implementations of the present disclosure. Method 500 is performed by processing logic that can include hardware (circuitry, dedicated logic, etc.), software (such as is run on a general-purpose computer system or a dedicated machine), firmware, or some combination thereof. In one implementation, method 500 can be performed by a computer system, such as manufacturing system 100 of FIG. 1. In other or similar implementations, one or more operations of method 500 can be performed by one or more other machines not depicted in the figures. In some aspects, one or more operations of method 440 can be performed by client device 110, predictive system 160, server machine 170, server machine 180, and/or predictive server 190.

At operation 510, processing logic receives feedback data with respect to a corrective action performed to address an issue that caused a failure of a process tool. For example, the feedback data can be received from a user device via a user interface (e.g., user device 150 of FIG. 1). The at least one processing device can receive feedback data indicating whether the corrective action provided by the at least one processing device worked.

At operation 520, processing logic updates, based on the feedback data, a mechanism used to determine the corrective action. In some implementations, updating the mechanism used to determine the corrective action includes causing at least one data store to be updated based on the feedback data (e.g., data store 140 of FIG. 1, data store 250 of FIG. 2 and/or data store 310 of FIG. 3). In some implementations, updating the mechanism used to determine the corrective action includes causing at least one machine learning model to be trained (e.g., retrained) based on the feedback data (e.g., model 165 of FIGS. 1 and 3).

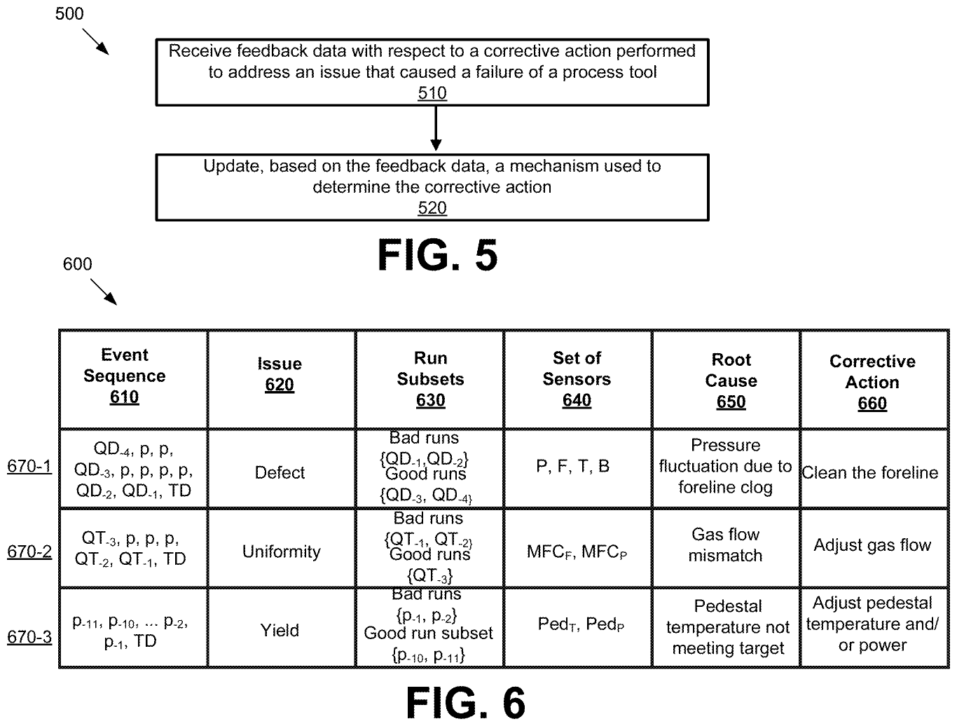

FIG. 6 is a table 600 illustrating example scenarios for implementing autonomous equipment diagnostics for manufacturing systems by analyzing process runs, according to aspects of the present disclosure. For example, table 600 includes multiple columns including event sequence column 610, issue column 620, run subsets column 630, set of sensors column 640, root cause column 650, and corrective action column 660, and multiple rows including rows 670-1 through 670-3.

Row 670-1 corresponds to event sequence {QD₋₁, p, p, QD₋₃, p, p, p, p, QD₋₂, QD₋₁, TD}. For illustrative purposes, each QD is shown having an index l defining its location in the sequence relative to TD (QDₙ). For example, QD₋₁ refers to the first QD that precedes TD, QD₋₂ refers to the second QD that precedes TD, QD₋₃ refers to the third QD that precedes TD, and QD₋₄ refers to the third QD that precedes TD. It is determined that the issue identified for this event sequence is a defect issue (e.g., based on the fault pattern {QD, QD, TD} as described above). The bad run set is identified as {QD₋₁, QD₋₂} and the good run set is identified as {QD₋₃, QD₋₄}. It is determined based on a comparison of first sensor data from the set of bad runs {QD₋₁, QD₋₂} to second sensor data from the set of good runs {QD₋₃, QD₋₄} that the set of sensors includes a pressure sensor (P), a flow sensor (F), a temperature sensor (T), and an RF bias sensor (B) arranged in ranked order. The set of sensors indicates that the root cause of the defect issue is a pressure fluctuation due to a foreline clog (e.g., from P and T). The corrective action is determined to be clean the foreline. For example, the corrective action can be provided as a message to a user identifying that the issue can be addressed by cleaning the foreline. As another example, the corrective action can be provided without additional user interaction by causing a robot to clean the foreline.

Row 670-2 corresponds to event sequence {QT₋₃, p, p, p, QT₋₂, QT₋₁, TD}. For illustrative purposes, each QT is shown having an index m defining its location in the sequence relative to TD (QTₘ). For example, QT₋₁ refers to the first QT that precedes TD, QT₋₂ refers to the second QT that precedes TD, and QT₋₃ refers to the third QD that precedes TD. It is determined that the issue identified for this event sequence is a uniformity issue (e.g., based on the fault pattern {QT, QT, TD}). The bad run set is identified as {QT₋₁, QT₋₂} and the good run set is identified as {QT₋₃}. It is determined based on a comparison of first sensor data from the set of bad runs {QT₋₁, QT₋₂} to second sensor data from the set of good runs {QT₋₃} that the set of sensors includes a mass flow controller (MFC) gas flow sensor (MFC_{F}) and an MFC pressure sensor (MFC_{P}) arranged in ranked order. The set of sensors indicates that the root cause of the uniformity issue is a gas flow mismatch. The corrective action is determined to be to cause the MFC to adjust the gas flow. For example, corrective action can be provided as a message to a user identifying that the issue can be addressed by causing the MFC to adjust the gas flow. As another example, the corrective action can be provided without additional user interaction by having a processing device cause the MFC to adjust the gas flow.

Row 670-3 corresponds to event sequence {p₋₁₁, p₋₁₀, . . . , p₋₂, p₋₁, TD}. For illustrative purposes, each p is shown having an index n defining its location in the sequence relative to TD (pₙ). For example, p₋₁ refers to the first QT that precedes TD, p₋₂ refers to the second QT that precedes TD, . . . p₋₁₀ refers to the tenth QD that precedes TD, and p₋₁₁ refers to the eleventh QD that precedes TD. It is assumed that the event sequence further includes p₋₃ through p₋₉. It is determined that the issue identified for this event sequence is a yield issue (e.g., based on the fault pattern {p, p, TD}). The bad run set is identified as {p₋₁, p₋₂} and the good run set is identified as {p₋₁₀, p₋₁₁}. It is determined based on a comparison of first sensor data from the set of bad runs {p₋₁, p₋₂} to second sensor data from the set of good runs {p₋₁₀, p₋₁₁} that the set of sensors includes a pedestal temperature sensor (Ped_{T}) and a pedestal pressure sensor (PED_{P}) arranged in ranked order. The set of sensors indicates that the root cause of the yield issue is that the pedestal temperature is not meeting a target temperature. The corrective action is determined to be to adjust the pedestal temperature and/or power. For example, corrective action can be provided as a message to a user identifying that the issue can be addressed by adjusting the pedestal temperature and/or power. As another example, the corrective action can be provided without additional user interaction by having a processing device cause the adjustment to the pedestal temperature and/or power.

In any of these scenarios, a user can provide, to a processing device, feedback data regarding the corrective action. Such feedback can be used to update data used to identify the root cause represented by column 650 and/or the corrective action represented by column 660.

For example, if cleaning the foreline successfully addressed the defect issue of row 670-1, then the user can indicate the same via a GUI displayed by the user device (e.g., by selecting a button in the GUI indicating that the corrective action successfully addressed the issue). Such positive feedback data may have no effect any of the data used to identify the root cause represented by column 650 and/or the corrective action represented by column 660.

Otherwise, if cleaning the foreline failed to address the defect issue of row 670-1, then the user can indicate the same via the GUI (e.g., selecting a button in the GUI indicating that the corrective action failed to address the issue). Such negative feedback data can cause an update to data used to identify the root cause represented by column 650 and/or the corrective action represented by column 660.

For example, determining that cleaning the foreline failed to address the defect issue of row 670-1 from the feedback data can cause an update to the runs of the event sequence selected for the set of bad runs and/or the runs of the event sequence selected for the set of good runs represented by column 630. The update to the set of bad runs and the set of good runs can change the sensor data that is compared to identify the set of sensors, and thus can change the set of sensors represented by column 640. Changing the set of sensors can impact the root cause represented by column 650.

As another example, determining that cleaning the foreline failed to address the defect issue of row 670-1 from the feedback data can cause an update to the set of sensors represented by column 640 (e.g., without changing the sets of bad runs and good runs). That is, the feedback data can affect the method used to generate the set of sensors represented by column 640. For example, changing the ranking/order of the set of sensors represented by column 640 can cause a change in the root cause represented by column 650.

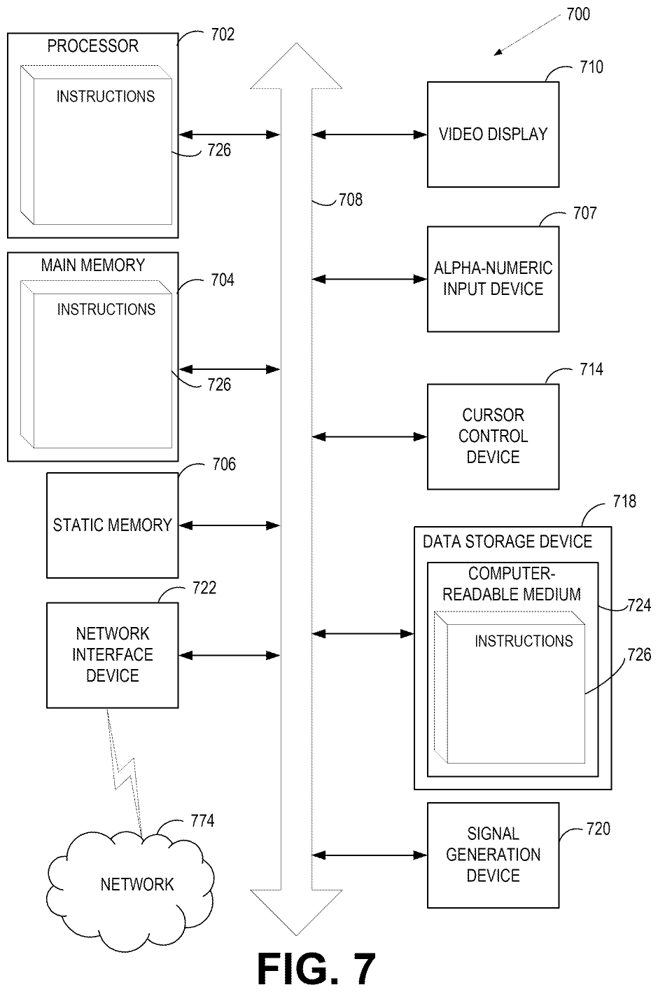

FIG. 7 is a block diagram illustrating a computer system 700, according to certain implementations. In some implementations, computer system 700 can be connected (e.g., via a network, such as a Local Area Network (LAN), an intranet, an extranet, or the Internet) to other computer systems. Computer system 700 can operate in the capacity of a server or a client computer in a client-server environment, or as a peer computer in a peer-to-peer or distributed network environment. Computer system 700 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 can include a processing device 702, a volatile memory 704 (e.g., Random Access Memory (RAM)), a non-volatile memory 706 (e.g., Read-Only Memory (ROM) or Electrically-Erasable Programmable ROM (EEPROM)), and a data storage device 716, which can communicate with each other via a bus 708.

Processing device 702 can be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 700 can further include a network interface device 722 (e.g., coupled to network 774). Computer system 700 also can include a video display unit 710 (e.g., an LCD), an alphanumeric input device 712 (e.g., a keyboard), a cursor control device 714 (e.g., a mouse), and a signal generation device 720.

In some implementations, data storage device 716 can include a non-transitory computer-readable storage medium 724 on which can store instructions 726 encoding any one or more of the methods or functions described herein, including instructions encoding components of FIG. 1 and for implementing methods described herein.

Instructions 726 can also reside, completely or partially, within volatile memory 704 and/or within processing device 702 during execution thereof by computer system 700, hence, volatile memory 704 and processing device 702 can also constitute machine-readable storage media.

While computer-readable storage medium 725 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method, comprising:
obtaining an event sequence related to a set of runs performed by a process tool that has failed;
determining, using the event sequence, an issue causing a failure of the process tool;
identifying, based on the issue, a first subset of runs from the set of runs and a second subset of runs from the set of runs;
identifying, based on the first subset of runs and the second subset of runs, a corrective action to address the issue that caused the failure; and
causing the corrective action to be provided.

2. The method of claim 1, wherein the event sequence comprises data indicative of a set of events that resulted from the set of runs, and wherein each event of the set of events is represented by an event code defined for the event.

3. The method of claim 2, wherein obtaining the event sequence comprises:
receiving raw event sequence data related to the set of runs; and
generating the event sequence by processing the raw event sequence data, including assigning the event code to each event.

4. The method of claim 1, wherein determining the issue comprises comparing the event sequence to a set of predefined fault patterns to identify a fault pattern corresponding to the issue.

5. The method of claim 1, wherein determining the issue comprises using a machine learning model trained to infer the issue from the event sequence.

6. The method of claim 1, wherein identifying the corrective action comprises:
identifying a set of sensors by comparing first sensor data from the first subset of runs to second sensor data from the second subset of runs;
determining a root cause of the issue based on the set of sensors; and
determining the corrective action based on the root cause.

7. The method of claim 6, wherein determining the root cause comprises at least one of: identifying the root cause using information mapping the set of sensors to the root cause in a data store, or using a machine learning model trained to infer the root cause from data representing the set of sensors.

8. The method of claim 6, wherein determining the corrective action from the root cause comprises at least one of: identifying the corrective action using information mapping the root cause to the corrective action in a data store, or using a machine learning model trained to infer the corrective action from the root cause.

9. The method of claim 8, further comprising:
receiving feedback data with respect to the corrective action; and
updating, based on the feedback data, the information mapping the root cause to the corrective action in the data store, or retraining the machine learning model based on the feedback data.

10. The method of claim 1, wherein the issue is one of:
a defect issue associated with a first qualification run performed by the process tool;
a uniformity issue associated with a second qualification run performed by the process tool; or
a yield issue associated with a process run performed by the process tool.

11. A system, comprising:
a memory; and
a processing device, operatively coupled to the memory, to perform operations comprising:
obtaining an event sequence related to a set of runs performed by a process tool that has failed;
determining, using the event sequence, an issue causing a failure of the process tool;
identifying, based on the issue, a first subset of runs from the set of runs and a second subset of runs from the set of runs;
identifying, based on the first subset of runs and the second subset of runs, a corrective action to address the issue that caused the failure; and
causing the corrective action to be provided.

12. The system of claim 11, wherein the event sequence comprises data indicative of a set of events that resulted from the set of runs, and wherein each event of the set of events is represented by an event code defined for the event.

13. The system of claim 12, wherein obtaining the event sequence comprises:
receiving raw event sequence data related to the set of runs; and
generating the event sequence by processing the raw event sequence data, including assigning the event code to each event.

14. The system of claim 11, wherein determining the issue comprises comparing the event sequence to a set of predefined fault patterns to identify a fault pattern corresponding to the issue.

15. The system of claim 11, wherein determining the issue comprises using a machine learning model trained to infer the issue from the event sequence.

16. The system of claim 11, wherein identifying the corrective action comprises:
identifying a set of sensors by comparing first sensor data from the first subset of runs to second sensor data from the second subset of runs;
determining a root cause of the issue based on the set of sensors; and
determining the corrective action based on the root cause.

17. The system of claim 16, wherein determining the root cause comprises at least one of: identifying the root cause using information mapping the set of sensors to the root cause in a data store, or using a machine learning model trained to infer the root cause from data representing the set of sensors.

18. The system of claim 16, wherein determining the corrective action from the root cause comprises at least one of: identifying the corrective action using information mapping the root cause to the corrective action in a data store, or using a machine learning model trained to infer the corrective action from the root cause.

19. The system of claim 11, wherein the operations further comprise:
receiving feedback data with respect to the corrective action; and
updating, based on the feedback data, the information mapping the root cause to the corrective action in the data store, or retraining the machine learning model based on the feedback data.

20. The system of claim 1, wherein the issue is one of:
a defect issue associated with a first qualification run performed by the process tool;
a uniformity issue associated with a second qualification run performed by the process tool; or
a yield issue associated with a process run performed by the process tool.
